(19) United States
(12) Patent Application Publication
(10) Pub. No.: US 2006/0038479 A1
(43) Pub. Date: Feb. 23, 2006

(54) Display device

(76) Inventors: Nobuhiko Fukuoka, Ebina (JP); Nobuyuki Ushifusa, Yokohama (JP); Toshiaki Kusunoki, Tokorozawa (JP); Kazutaka Tsuji, Hachioji (JP); Hiroshi Kikuchi, Zushi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/205,199

(22) Filed: Aug. 17, 2005

(30) Foreign Application Priority Data
Aug. 17, 2004 (JP) 2004-237166

(51) Int. Cl. H01J 1/62; H01J 63/04

(52) U.S. Cl. 313/493

(57) ABSTRACT

In the display device having a plurality of electron emitter elements and an internal circuit connected to the electron emitter elements both being formed on a substrate and sealed within a sealing member, the present invention provides a lead line passing through the sealing member to connect the internal circuit with an external circuit and forms the internal circuit smaller in resistivity (specific resistance) than the lead line by e.g. forming the lead line thinner than the internal circuit to suppress voltage drop in the internal circuit as well as to secure the predetermined sealing condition of the electron emitter elements and the internal circuit.

The present application claims priority from Japanese application JP2004-237166 filed on Aug. 17, 2004, the content of which is hereby incorporated by reference into this application.

### BACKGROUND OF THE INVENTION

1. Field of the Invention

The present invention relates to a display device having an electron emission element (electron emission source) for each pixel typified by a field-emission-type image display device, and relates to a substrate (display substrate) for use in the device.

2. Description of the Related Art

Japanese patent literature JP-A-2004-111053 (and its counterpart US 2004/017160) describes a panel (display substrate, sometimes mentioned as FED substrate) for use in a field-emission-type image display device (Field Emission Display). FIG. 19 is a plane view of the FED substrate. FIG. 20 is a section view along a B-B direction of FIG. 19. As shown in figures, the FED substrate disclosed in JP-A-2004-111053 is configured in a way that a cathode substrate 610 on which data lines 670 and scan lines 630 are disposed crosswise, an anode substrate 620 on which a black matrix, a phosphor layer, and an anode electrode are formed are disposed parallel with frame glass between them. Electron emission sources are provided at portions where the data lines 670 are intersected with the scan lines 630. A space between the frame glass 650 and the cathode substrate 610 or the anode substrate 620 is sealed by glass frit 651, 652 in order to prevent leakage therethrough. The inside 615 of the substrate is evacuated such that the electron emission sources can emit electrons.

### SUMMARY OF THE INVENTION

To achieve increase in size of a screen, a voltage drop in the scan lines needs to be suppressed to reduce unevenness in luminance along the scan lines. For example, in the FED substrate in JP-A-2004-111053, a method for suppressing the voltage drop by broadening the scan lines to reduce a resistance value is considered.

However, when the scan line is broadened, separation or a crack tends to occur easily at a sealing portion using the glass frit due to internal stress in the scan lines, resulting in deterioration in airtightness of the inside of the substrate.

The invention was made in the light of the above circumstance, and an object of the invention is to provide a technique for sealing an internal circuit more securely with the voltage drop in the internal circuit being suppressed in a panel having a connection wiring line to an external circuit.

To solve the above problem, in a display substrate of the invention, a wiring line of the internal circuit and a lead line at the sealing portion are formed in accordance with different specifications respectively. For example, the wiring line of the internal circuit is specified as low resistance, and the lead line at the sealing portion is specified to have a small thickness to the extent of preventing leakage through that sealing portion.

Specifically, the display substrate of the field-emission-type image display device of the invention has scan lines formed within the display substrate, a sealing portion for sealing the inside of the display substrate, and lead lines for connecting the scan lines to an external circuit through the sealing portion; wherein the scan lines are formed to have low resistance to the extent that the voltage drop in the scan lines falls within the allowable range, and thickness of the lead lines at the sealing portion is formed small to the extent that the inside of the display substrate can be sealed.

Moreover, the display substrate of the field-emission-image display device of the invention has the sealing portion for sealing the inside of the display substrate, and the lead lines for connecting the scan lines within the display substrate to the external circuit; wherein at least part of the scan lines are formed from a material having lower resistivity than that of the lead lines at the sealing portion.

Moreover, at least part of the scan lines can be formed using wiring lines having a thickness larger than that of the lead lines at the sealing portion.

Moreover, the display substrate of the field-emission-type image display device of the invention can be one that has the sealing portion for sealing the inside of the display substrate, first wiring lines which form the scan lines within the display substrate and is connected to the external circuit through the sealing portion, and second wiring lines that overlap at least part of the portion of the first wiring lines forming the scan lines and form the scan lines.

Moreover, the display substrate of the field-emission-type image display device of the invention can be one that has the sealing portion for sealing the inside of the display substrate, first wiring lines forming the scan lines within the display substrate, and second wiring lines which overlap at least part of the first wiring lines, form part of the scan lines, and are connected to the external circuit through the sealing portion.

The display substrate described above is incorporated into a display device in a form of a substrate having a main surface of which the inner area (area that may be called display area) has multiple electron emission elements disposed thereon, and wiring lines to be connected to the electron emission elements are formed on the inner area of the main surface of the substrate. The inner area of the main surface of the substrate, particularly an image display area in the display device (display panel) is sealed by a sealing member, and left at a pressure lower than the ambient atmosphere of the display device (so-called, vacuum). Wiring lines (not limited to the scan lines) as a feature of the invention are left in a space kept at the low pressure (for example, 1×10⁻⁴ Pa or lower), and connected to the external circuit provided outside the space by the lead lines as a feature of the invention.

### BRIEF DESCRIPTION OF THE DRAWINGS

FIG. 1 is a plane view of an FED substrate according to a first embodiment of the invention;

FIG. 2 is a section view along an A-A direction of FIG. 1;

FIG. 3 is a plane view of a substrate for illustrating a method for manufacturing the FED substrate according to the first embodiment;

FIG. 4 is a section view along a direction corresponding to an A-A direction of FIG. 3;

FIG. 5 is a section view along a direction corresponding to the A-A direction of FIG. 3;

FIG. 6 is a plane view of a substrate for illustrating a method for manufacturing an FED substrate according to a second embodiment;

FIG. 7 is a section view along a direction corresponding to an A-A direction of FIG. 6;

FIG. 8 is a plane view of a board for illustrating a method for manufacturing the FED board according to the second embodiment;

FIG. 9 is a section view along a direction corresponding to an A-A direction of FIG. 8;

FIG. 10 is a section view along a direction corresponding to the A-A direction of FIG. 8;

FIG. 11 is a plane view of an FED substrate according to a third embodiment of the invention;

FIG. 12 is a section view along an A-A direction of FIG. 11;

FIG. 13 is a plane view of a substrate for illustrating a method for manufacturing the FED substrate according to the third embodiment;

FIG. 14 is a section along a direction view corresponding to an A-A direction of FIG. 13;

FIG. 15 is a section view along a direction corresponding to the A-A direction of FIG. 13;

FIG. 16 is a section view along a direction corresponding to the A-A direction of FIG. 13;

FIG. 17A to FIG. 17C are plane views showing a scan line and a lead line in an enlarged manner;

FIG. 18 is a section view of an FED substrate according to a modification of the embodiment of the invention, along a direction corresponding to the A-A direction of FIG. 1;

FIG. 19 is a plane view of an FED substrate according to an example of the related art;

FIG. 20 is a section view along a B-B direction of FIG. 19; and

FIG. 21 is a section view along an A-A direction of an FED substrate according to a modification of the embodiment of the invention.

### DETAILED DESCRIPTION OF THE INVENTION

Preferred embodiments of a display device of the invention will be described with reference to drawings. While a substrate that exhibits structural features of the display device of the invention is described as “FED substrate” in the following description, the substrate can be provided with a plurality of electron emission elements and wiring lines concerned with driving the elements on its main surface. In other words, even if a substrate in which electrodes or their equivalents for forming an electric field by which electrons are emitted can not be provided due to a shape of the electron emission elements is used, the following aspects can be realized.

### FIRST EMBODIMENT

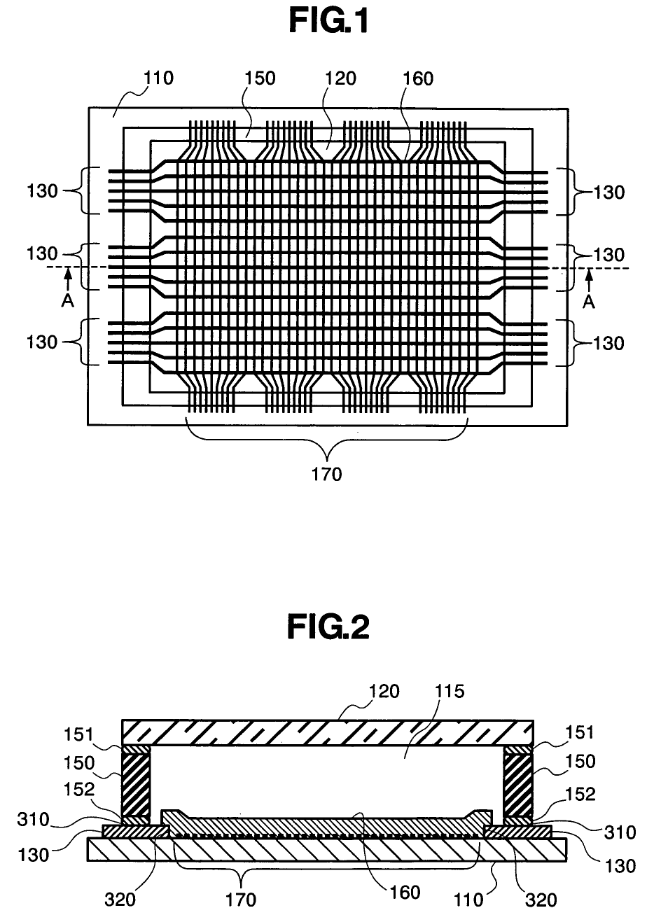

FIG. 1 is a plane view showing a schematic configuration of an FED (Field Emission Display) substrate according to a first embodiment of the invention. FIG. 2 is a section view along an A-A direction of the FED substrate of FIG. 1. As shown in the figures, the FED substrate of the embodiment is configured in a way that a cathode substrate 110 and an anode substrate 120 are disposed oppositely via frame glass 150.

The cathode substrate 110 is formed by an insulative substrate such as glass. Data lines 170 and scan lines 160 are provided crosswise on the cathode substrate 110. The data lines 170 are formed from Al or Al alloys. Thickness of the data lines 170 is typically within a range of 100 to 500 nm. Ends of the data lines 170 are connected to a data-line drive circuit (not shown) that is an external circuit.

Each of the scan lines 160 is typically formed from Ag, Au, Cu, and Pd or alloys of them, however, it is preferably formed from Ag in terms of low resistance (small resistivity) and particularly ease in manufacturing. Thickness of the scan lines 160 is typically within a range of 1 to 30 μm, and preferably 5 to 20 μm. Line width of them is typically within a range of 50 to 600 μm. However, the thickness or line width of the scan lines is preferably determined to have a predetermined resistance value such that a voltage drop in the scan lines falls within its allowable range. Each of the scan lines 160 is connected to a scan-line lead line 130 on the cathode substrate 110 at a bonding portion 320.

The scan-line lead lines 130 are wiring lines for connecting the scan lines to the scan-line drive circuit (not shown) that is an external circuit through a sealing portion 310. The scan-line lead lines 130 are typically formed from Al, Cu, Cr or alloys of them; however, they are preferably formed from Al in terms of ease in manufacturing. Thickness of the scan-line lead lines 130 is typically within a range of 100 to 500 nm in terms of perfect sealing at the sealing portion 310.

A cold cathode electron source (not shown) is provided at a position where the data line 170 intersects with the scan line 160. The cold cathode electron source is roughly classified into a field-emission-type electron source such as Spindt-type electron source, surface-conduction-type electron source, and carbon-nanotube-type electron source, and a hot-electron-type electron source such as MIM (Metal-Insulator-Metal) type electron source having a stacked metal/insulator/metal layers and MIS (Metal-Insulator-Semiconductor) type electron source having a stacked metal/insulator/semiconductor layers, and either of the electron sources can be provided. For example, the MIM type electron source, which is disclosed in Japanese patent literatures JP-A-10-153979 and JP-A-2004-111053, may be disposed.

The anode substrate 120 is formed by a transparent glass plate. A black matrix, a phosphor layer and an anode electrode are formed on one surface of the anode substrate 120 and arranged such that the formation surface is opposed to a wiring formation surface of the cathode substrate 110. The black matrix is formed from chromium oxide. The phosphor may comprise, for example, Y₂O₂S:Eu (P22-R) for red, ZnS:Cu, Al (P22-G) for green, and ZnS:Ag (P22-B) for blue.

A space between the frame glass 150 and the cathode substrate 110 or the anode substrate 120 is sealed using an adhesive 151, 152 such as glass frit such that pressure of the inside 115 of the substrate can be kept at about 10⁻⁵ Pa.

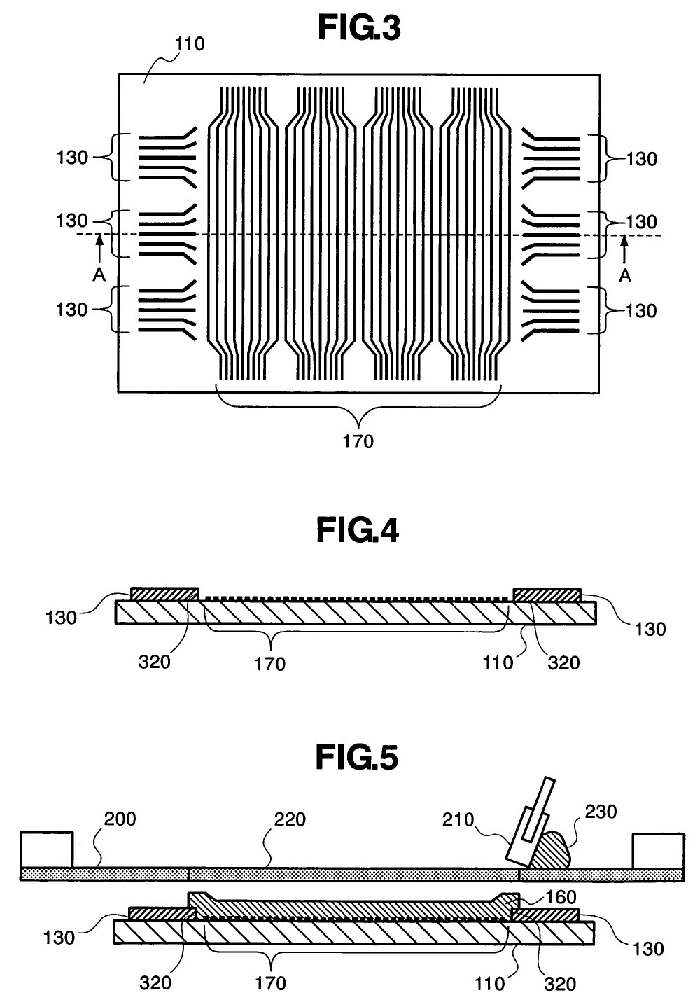

Next, a method for manufacturing the FED substrate of the first embodiment is described. FIG. 3 is a plane view of the substrate, and FIG. 4 and FIG. 5 are section views along a direction corresponding to an A-A direction of FIG. 3.

First, the data lines 170 are formed on the cathode substrate (glass substrate) 110 with the electron sources such as MIM electron sources. The data lines can be formed from Al or Al alloys using sputter, photolithography, or etching. The data lines are typically formed to have the thickness within the range of 100 to 500 nm.

Next, as shown in FIG. 3 and FIG. 4, the scan-line lead lines 130 are formed on the cathode substrate 110. The scan-line lead lines 130 can be formed using Al or Al alloys, Cu, Cr or alloys of them by the sputter, photolithography, or etching. The lead lines are typically formed to have the thickness within the range of 100 to 500 nm in terms of perfect sealing.

Next, the scan lines 160 are formed on the cathode substrate 110. A formation method is not particularly limited as long as it can form the scan lines 160. Hereinafter, a method for forming the scan lines using Ag is described.

Here, screen printing is used as shown in FIG. 5. That is, Ag paste 230 is rubbed from an upside of a screen printing plate 200 having a pattern 220 corresponding to a form (straight line) of an area of Ag wiring lines using a squeeze 210. Thus, the Ag paste 230 is applied on the cathode substrate 110. At that time, both ends of the Ag wiring lines 160 are made to contact to the scan-line lead line 130. After that, the Ag paste is heated to remove solvent and a binder therein, and make Ag particles in the Ag paste to be fusion-bonded to one another.

As the Ag paste, paste that can be baked at a temperature lower than an allowable temperature limit of the electron sources provided on the cathode substrate 110 is preferably used. For example, when the MIM electron sources are provided on the cathode substrate 110, since the allowable temperature limit of the MIM electron source is about 430° C., Ag paste that can be baked at 430° C. or lower is preferably used. Specifically, frit-contained XFP5369-50L (manufactured by NAMICS CORPORATION, heating condition: temporal drying; 150° C. for 15 min, and baking; 430° C. for 30 min) can be used.

The Ag wiring lines are typically formed to have a thickness within a range of 1 to 30 μm. In addition, the wiring lines are typically formed to have a line width within a range of 100 to 300 μm.

The screen printing may be performed several times to increase thickness. For example, the Ag paste is printed in first printing and then dried, and then overprinted in second printing and dried, and then baked. According to this, when an Ag wiring line about 7 μm in thickness is obtained in the first printing, an Ag wiring line about 12 μm in thickness can be obtained in the second printing.

Next, as shown in FIG. 2, the anode substrate having the black matrix, phosphor layer and anode electrode formed on one surface is arranged such that the formation surface is opposed to the wiring formation surface of the cathode substrate 110 via the frame glass 150. At that time, the glass frit 151, 152 is applied into the space between the frame glass 150 and the anode substrate 120 or the cathode substrate 110. Then, the applied glass frit 151, 152 is heated to be fused, and then cooled to be hardened, and thus adhered to the substrates.

As the glass frit 151, 152 used for the adhesive, one that can be fused at a temperature lower than the allowable temperature limit of the electron sources is preferably used. For example, when the MIM electron sources are provided on the cathode substrate 110, glass frit that can be fused at 430° C. or lower is preferably used.

Next, the inside 115 of the substrate is evacuated to about 10⁻⁵ Pa of pressure of the inside 115 through an exhaust port (not shown) using a vacuum pump, and then sealed.

Hereinbefore, the FED substrate according to the first embodiment has been described.

According to the embodiment, since the scan lines and the lead lines are separately formed, each can be specified differently. That is, since the scan lines can be formed from Ag having low resistance, the voltage drop in the scan lines can be suppressed. On the other hand, since the lead lines have short distance, they can be sufficiently secured to have small thickness. Therefore, even if heating is performed at high temperature to fuse the glass frit, the separation or the crack due to the internal stress can be prevented, there by airtightness at the sealing portion can be improved.

The scan lines can be easily formed by Ag wiring lines using the screen printing having high mass-productivity. The screen printing is advantageous in patterning in a direction perpendicular to the squeeze, but disadvantageous in patterning in a direction diagonal or parallel to the squeeze because inferior application (bleed or run-out) easily occur. In the embodiment, as shown in FIG. 1, only a parallel and straight portion of the scan lines is formed by the screen printing. Narrow portions of the pattern are formed by sputter as the scan-line lead lines. Therefore, in the method for manufacturing the FED substrate of the embodiment, wiring lines that are reduced in run-out and beautiful can be efficiently formed.

### SECOND EMBODIMENT

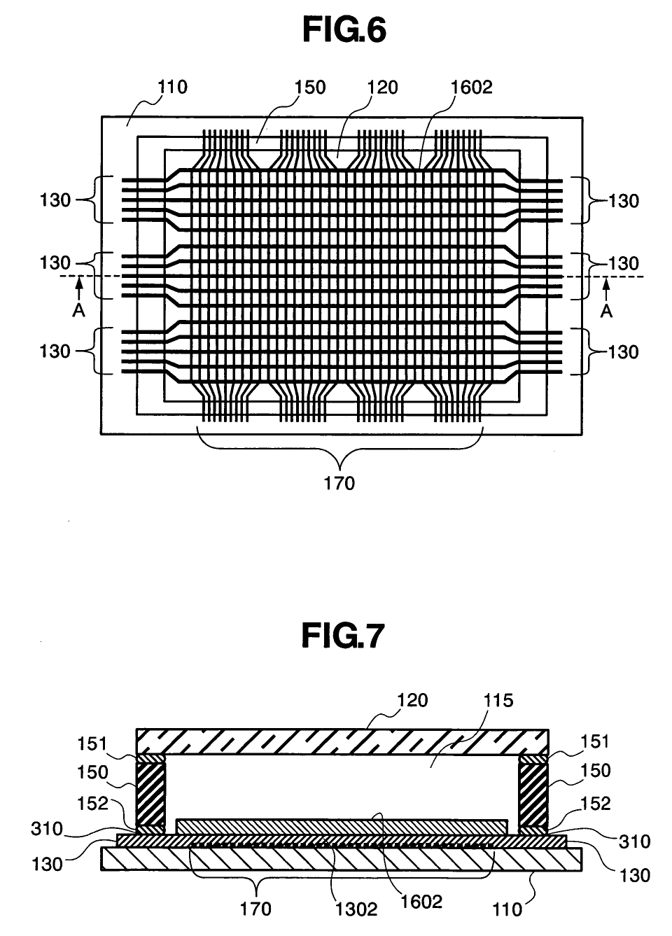

FIG. 6 is a plane view of an FED substrate according to a second embodiment. FIG. 7 is a section view along an A-A direction of FIG. 6. Description is omitted on parts that are configured in the same way as in the FED substrate of the first embodiment.

In the FED substrate of the first embodiment, the scan-line lead lines 130 were formed by wiring lines of Al in small thickness to secure the airtightness at the sealing portion 310. Moreover, the scan lines 160 were formed by wiring lines of Ag having low resistance to reduce resistance of the scan lines 160. On the contrary, in this embodiment, as shown in figures, the scan-line lead lines 130 extend to an area of scan lines, and forms part of scan lines 1302. To reduce resistance of the scan lines, wiring lines 1602 of Ag having low resistance is overlapped the scan line portion 1302. That is, the scan lines are formed by a combination of the wiring 1302 and the wiring 1602.

The scan-line lead lines 130 partially combined with the scan lines are typically formed from Al, Cu, Cr or alloys of them similarly as the scan-line lead lines of the FED substrate of the first embodiment; however, they are preferably formed from Al in terms of ease in manufacturing. Thickness of the scan-line lead lines 130 is typically within a range of 100 to 500 nm in terms of perfect sealing at the sealing portion 310, and preferably within a range of 200 to 400 nm.

The wiring lines 1602 overlapped the wiring lines 1302 are typically formed from Ag, Au, Cu, Pd or alloys of them, similarly as the scan lines of the FED substrate of the first embodiment. Among them, they are preferably formed from Ag in terms of low resistance and ease in manufacturing. Line width of the wiring lines 1602 is typically within a range of 50 to 600 μm, and thickness of the wiring lines is typically within a range of 1 to 30 μm, and preferably 5 to 20 μm. However, the thickness or line width of the wiring lines 1602 is preferably determined to have a predetermined resistance value such that the voltage drop in the scan lines falls within its allowable range.

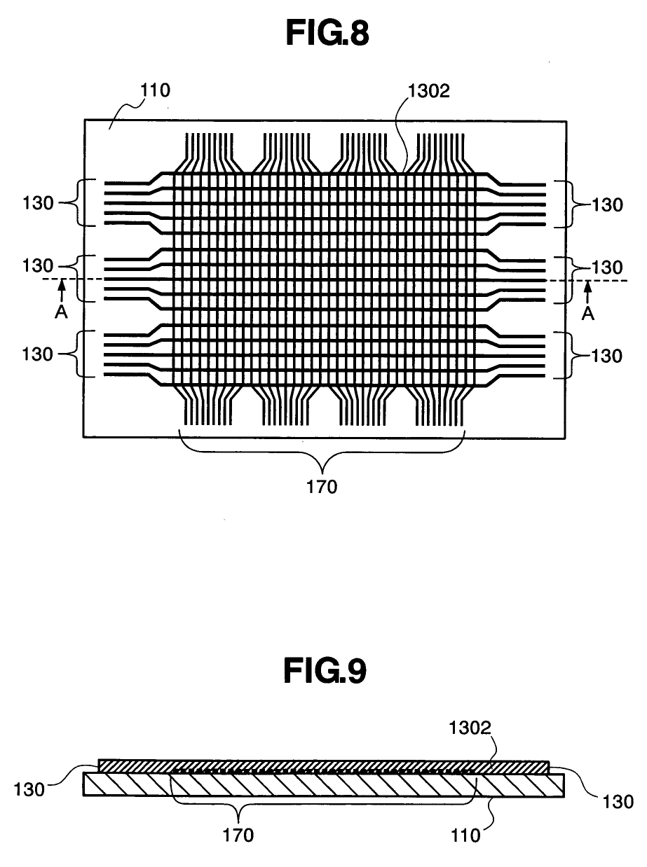

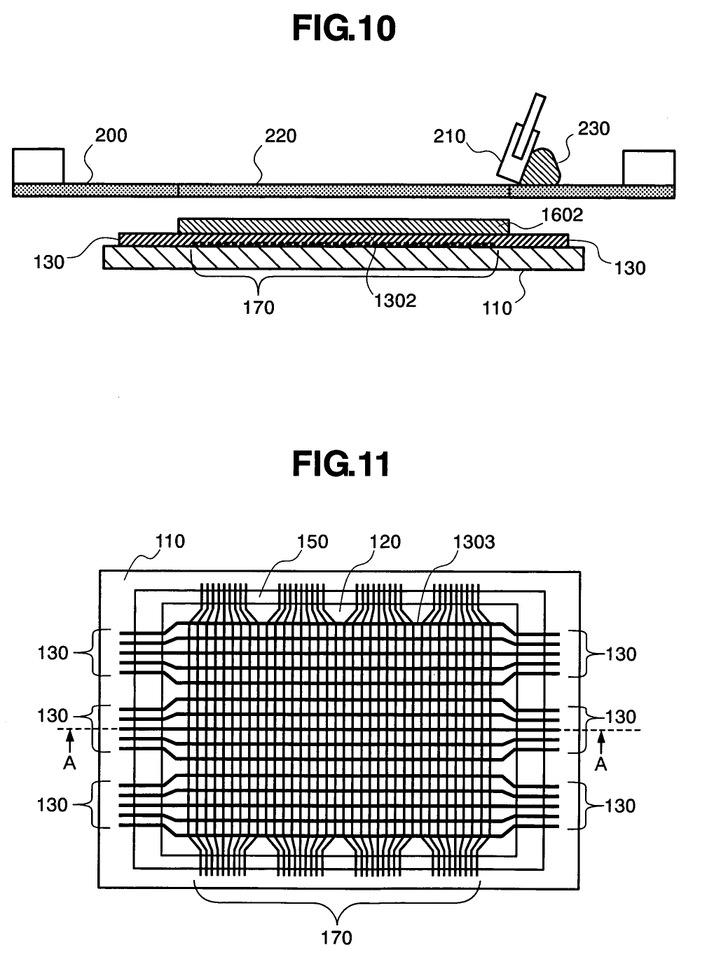

Next, a method for manufacturing the FED substrate of the second embodiment is described. FIG. 8 is a plane view of the substrate, and FIG. 9 and FIG. 10 are section views along a direction corresponding to an A-A direction of FIG. 8.

First, the data lines 170 are formed on the cathode substrate (glass substrate) 110 with the electron sources (not shown) such as MIM electron sources, similarly as the case of manufacturing the FED substrate of the first embodiment.

Next, as shown in FIG. 8 and FIG. 9, the scan-line lead lines 130 partially combined with the scan lines 1302 are formed on the cathode substrate 110. A method for forming the scan-line lead lines 130 is the same as the method for forming the scan-line lead lines 130 of the FED substrate of the first embodiment.

Next, to reduce resistance of the scan line portion, the wiring lines of Ag having low resistance are overlapped the scan lines 1302. Here, the screen printing is used as shown in FIG. 10. The screen printing is the same as in the case of the FED substrate of the first embodiment.

The Ag wiring is typically formed to have a thickness within a range of 1 to 30 μm. The screen printing may be performed several times to increase thickness similarly as the first embodiment.

Next, as shown in FIG. 7, the anode substrate 120 having the black matrix, phosphor layer and anode electrode formed on one surface is arranged such that the formation surface thereof is opposed to the wiring formation surface of the cathode substrate 110 via the frame glass 150 in the same manner as that of the first embodiment. At that time, the glass frit 151, 152 is applied into the space between the frame glass 150 and the anode substrate 120 or the cathode substrate 110. Then, the applied glass frit 151, 152 is heated to be fused, and then cooled to be hardened, and thus adhered to the substrates.

Next, the inside 115 of the substrate is evacuated to about 10⁻⁵ Pa of pressure of the inside 115 through the exhaust port (not shown) using the vacuum pump, and then sealed. In this way, the FED substrate as shown in FIG. 7 can be manufactured.

Hereinabove, the FED substrate of the second embodiment has been described. According to the embodiment, the scan-line portion and the lead-line portion can be configured in different specifications respectively. That is, the scan lines are formed by wiring lines of Al and wiring lines of Ag that have low resistance and are overlapped on the Al lines. Therefore, the voltage drop on the scan lines can be suppressed. On the other hand, since the lead lines need not be low resistive, the wiring lines of Al can be remained with sufficiently small thickness being secured. Therefore, even if heating is performed at high temperature to fuse the glass frit, the separation or the crack due to the internal stress can be prevented, thereby airtightness at the sealing portion can be improved.

### THIRD EMBODIMENT

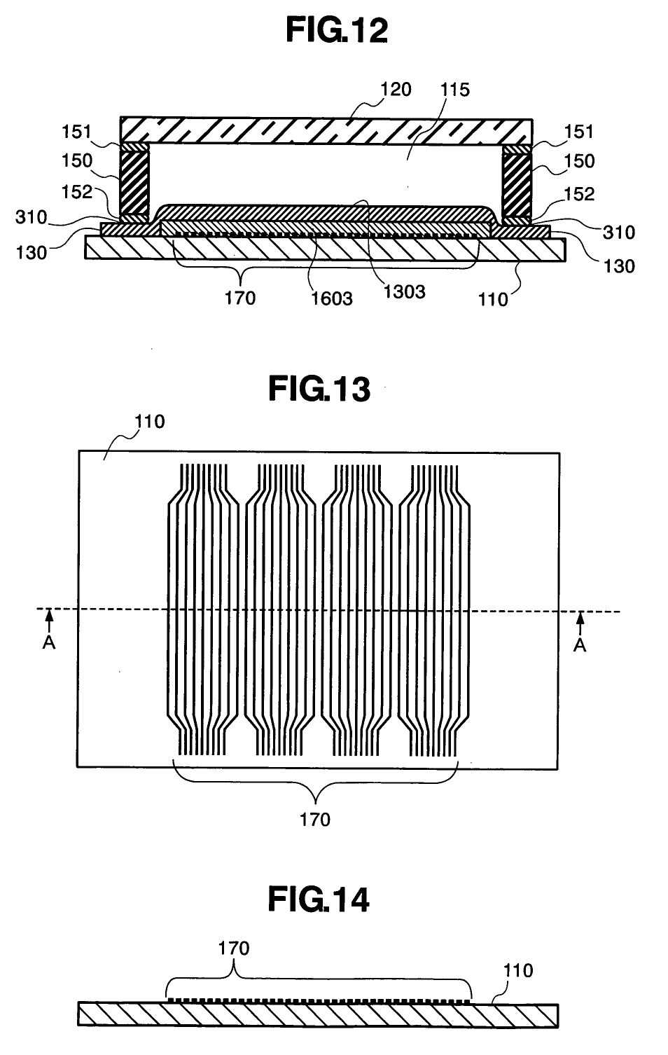

FIG. 11 is a plane view of an FED substrate according to a third embodiment. FIG. 12 is a section view along an A-A direction of FIG. 11. Description is omitted on parts that are configured in the same way as in the FED substrate of the first and second embodiments.

In the FED substrate of the second embodiment, the scan-line lead lines 130 were extended to an area of scan lines, forming part of scan lines 1302. In addition, to reduce resistance of the scan lines, wiring lines 1602 of Ag having low resistance were overlapped on the scan line portion 1302. On the contrary, as shown in FIG. 11 and FIG. 12, the FED substrate of this embodiment has a configuration where, first, scan lines 1603 are formed on the data lines 170 by wiring lines of Ag having low resistance, and then wiring lines 1303 extending to the scan-line lead-line portion are overlapped them.

The scan lines 1603 are typically formed from Ag, Au, Cu, Pd or alloys of them, similarly as the scan lines of the FED substrate of the first embodiment. Among them, they are preferably formed from Ag in terms of low resistance and ease in manufacturing. Line width of the wiring lines 1603 is typically within a range of 50 to 600 μm. Thickness of the scan lines 1603 is typically within a range of 1 to 30 μm in the light of decrease in resistance of the scan lines, and preferably 5 to 20 μm. However, the thickness or line width of the scan lines is preferably determined to have a predetermined resistance value such that the voltage drop in the scan lines falls within its allowable range.

The scan-line lead lines 130 partially combined with the scan lines 1303 are typically formed from Al, Cu, Cr or alloys of them similarly as the scan-line lead lines of the FED substrate of the first embodiment; however, they are preferably formed from Al in terms of ease in manufacturing. Thickness of the scan-line lead lines 130 is typically within a range of 100 to 500 nm at the sealing portion 310.

Next, a method for manufacturing the FED substrate of the third embodiment is described. FIG. 13 is a plane view of the substrate, and FIG. 14 to FIG. 16 are section views along a direction corresponding to an A-A direction of FIG. 13.

First, as shown in FIG. 13 and FIG. 14, the data lines 170 are formed on the cathode substrate (glass substrate) 110 with the electron sources (not shown) such as MIM electron sources, similarly as the case of manufacturing the FED substrate of the first embodiment.

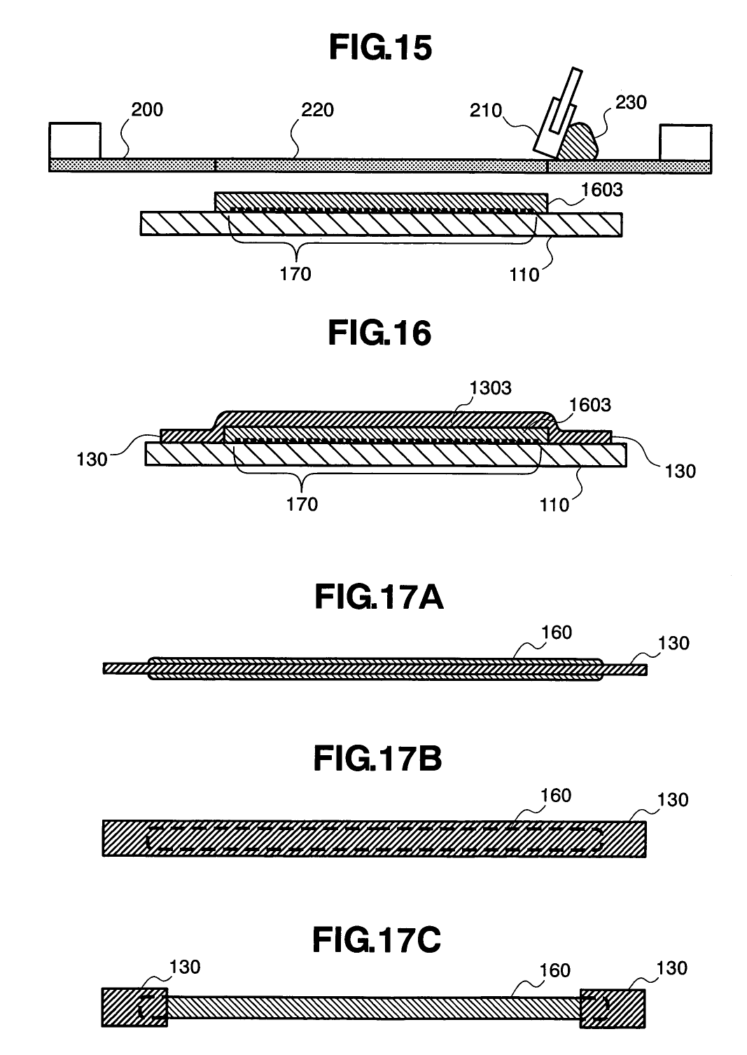

Next, the scan lines 1603 are formed by the wiring lines of Ag having low resistance. Here, the screen printing is used as shown in FIG. 15. The screen printing is the same as in the case of the FED substrate of the first embodiment.

The Ag wiring is typically formed to have a thickness within a range of 1 to 30 μm. The screen printing may be performed several times to increase thickness similarly as the first embodiment.

Next, as shown in FIG. 16, the wiring lines 1303 extending to the scan-line lead lines 130 are formed on the scan lines 1603. A method for forming the wiring lines 1303 is the same as the method for forming the scan-line lead lines 130 of the FED substrate of the first embodiment.

Next, as shown in FIG. 12, the anode substrate 120 having the black matrix, phosphor layer and anode electrode formed on one surface is arranged such that the formation surface thereof is opposed to the wiring formation surface of the cathode substrate 110 via the frame glass 150 in the same manner as that of the first embodiment. At that time, the glass frit 151, 152 is applied into the space between the frame glass 150 and the anode substrate 120 or the cathode substrate 110. Then, the applied glass frit 151, 152 is heated to be fused, and then cooled to be hardened, and thus adhered to the substrates.

Next, the inside 115 of the substrate is evacuated to about 10⁻⁵ Pa of pressure of the inside 115 through the exhaust port (not shown) using the vacuum pump, and then sealed. In this way, the FED substrate as shown in FIG. 12 can be manufactured.

Hereinabove, the FED substrate of the third embodiment has been described. According to the embodiment, the scan line portion and the lead line portion can be configured in different specifications respectively. That is, part of the scan lines are formed by the wiring lines of Ag having low resistance. Therefore, the voltage drop on the scan lines can be suppressed. On the other hand, since the lead lines need not be low resistive, the wiring lines of Al can be remained with sufficiently small thickness being secured. Therefore, even if heating is performed at high temperature to fuse the glass frit, the separation or the crack due to the internal stress can be prevented, thereby airtightness at the sealing portion can be improved.

In the third embodiment, the scan-line lead lines 130 forming the part of the scan lines may be formed such that the scan lines 160 formed from Ag are partially overlapped as shown in a plane view of FIG. 17A. Alternatively, the lines 130 may be formed such that they cover the scan lines 160 as shown in a plane view of FIG. 17B. Alternatively, the lines 130 may be formed such that they do not cover the scan lines 160 entirely, but cover only a portion near the scan-line lead portion as shown in a plane view of FIG. 17C.

Hereinabove, while description has been made on several embodiments of the invention, the invention is not limited to the embodiments. Various modifications of the embodiments can be made within a scope of the spirit of the invention.

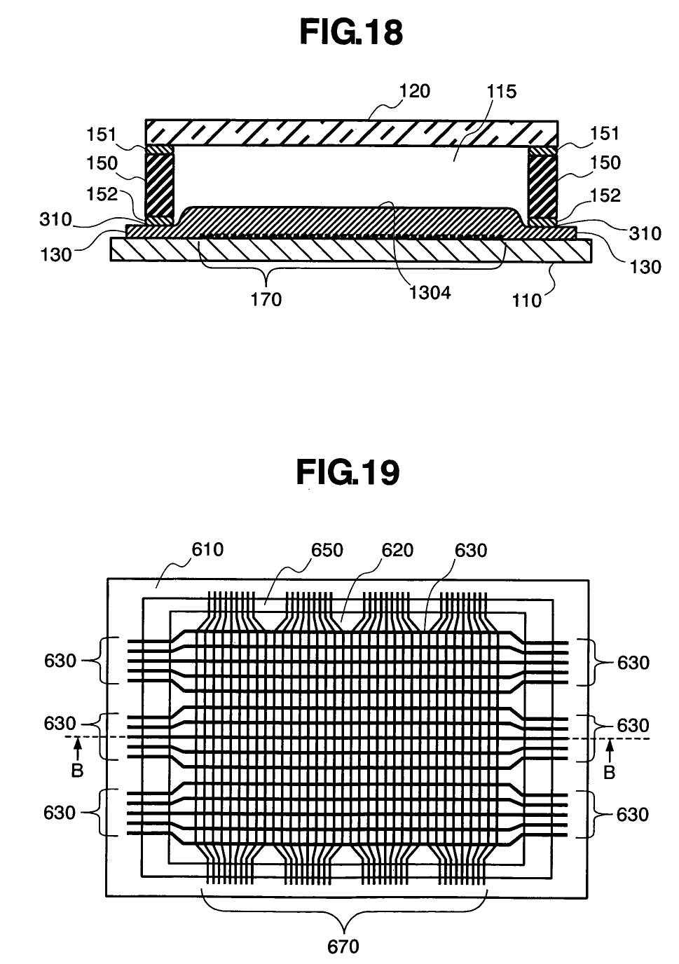

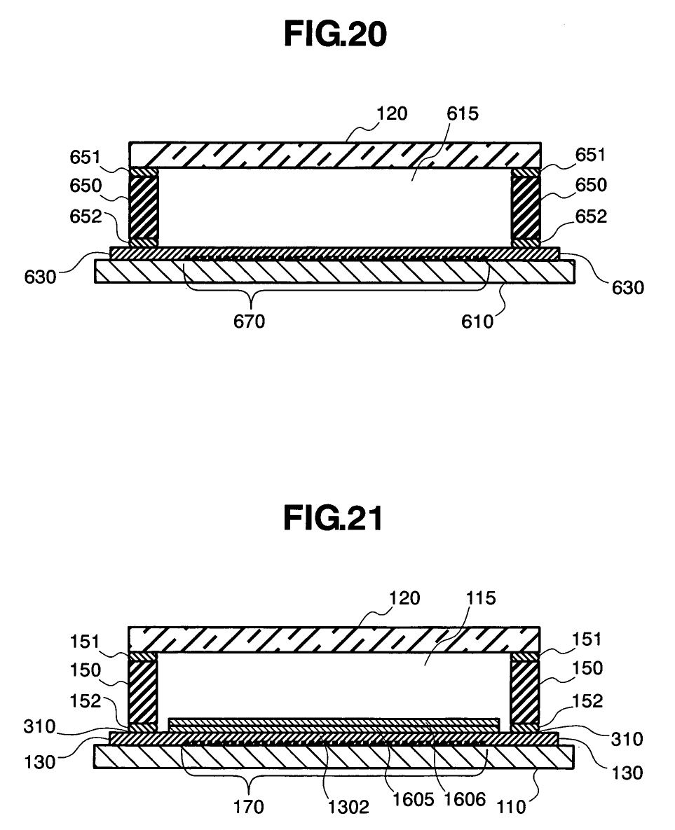

For example, while the scan line portion (or part of it) and scan-line lead-line portion are formed from different materials respectively, they may be formed from the same material as shown in 1304 of FIG. 18. In FIG. 18, thickness of the sealing portion 310 of the scan-line lead lines 130 is sufficiently small so as to seal the inside 115 of the substrate to be in vacuum. On the other hand, the scan-line portion 1304 is made to have larger thickness than that of the scan-line lead line portion 130 to suppress the voltage drop in the scan lines. Such wiring lines 1304, 130 of which the layer thickness is varied depending on regions can be formed by the sputter, photolithography, and etching. Alternatively, wiring lines having varied thickness can be formed by performing overprint several times on an area to be thickened.

As described above, the thickness or the line width of the scan lines is determined according to the allowable range of the voltage drop in the scan lines. More specifically, it is determined according to the allowable range of the resistance value determined according to the allowable range of the voltage drop. The allowable range of the voltage drop is typically within 0.5 V. For example, when a display screen size is 20 to 32 inches, length of the scan lines is 400 to 720 mm, and the resistance value of the scan lines is made to be 15 to 40 Ω so that the voltage drop falls within its allowable range. When the display screen size is 33 to 50 inches, length of the scan lines is 700 to 1200 mm, and the resistance value of the scan lines is made to be 6 to 15 Ω so that the voltage drop falls within its allowable range. When the display screen size is 51 to 65 inches, length of the scan lines is 1000 to 1500 mm, and the resistance value of the scan lines is made to be 3 to 6 Ω so that the voltage drop falls within its allowable range. The thickness or the line width of the scan lines is adjusted such that the resistance value falls within such resistance value ranges.

In the embodiments, in the process of forming the scan lines by screen printing, frit-contained metal paste (Ag paste) was used to improve adhesion to a base (in the example of FIG. 7 in the second embodiment, metal wiring 1302). However, the invention is not limited to this. Frit-free metal paste having lower resistance may be used. For example, the frit-contained metal paste is printed, and then the frit-free metal paste may be overprinted thereon. According to this, the scan lines having low resistance can be formed with further reduced thickness, while the improved adhesion to the base is secured. Alternatively, the frit-contained metal paste is printed, and then metal paste having low frit concentration (or metal paste having high metal concentration) compared with the printed metal paste may be used for the overprint.

For example, when frit-free Ag paste is used in the FED substrate of the second embodiment (FIG. 7), FIG. 21 is given. FIG. 21 is a section view along an A-A direction of the FED substrate. As shown in the figure, the substrate is in a configuration where a layer 1605 formed from the frit-contained Ag paste and a layer 1606 formed from the frit-free Ag paste are stacked in this order on metal wiring lines 1302 as the base. The layers form scan lines.

Such a configuration can be achieved in the following manner. First, frit-contained Ag paste (for example, XFP5369-50L (manufactured by NAMICS CORPORATION)) is applied on a wiring pattern of the scan lines and then subjected to temporal drying. Next, frit-free Ag paste (for example, XFP5369-50L-0 (manufactured by NAMICS CORPORATION, heating condition: temporal drying; 150° C. for 15 min, and baking; 430° C. for 30 min)) is applied by screen printing such that it overlaps the frit-contained Ag paste pattern. The frit-free Ag paste may be optionally overprinted. After that, the Ag paste is dried and then baked.

When the two layers are baked in an overlapped manner in this way, Ag particles are fusion-bonded to one another, thereby contact resistance between the two layers can be reduced.

The invention is not limited to the FED substrate. The invention can be applied to any substrate as long as it has a structure that an internal circuit is sealed from an external circuit, and has wiring lines for connecting the internal circuit to the external circuit.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

1-15. (canceled)

16. A display device, comprising:
a substrate having a principal surface in an inside of which a plurality of electron emitter elements are arranged;
a wiring line farmed in the inside of the principal surface of the substrate;
a sealing portion sealing the inside of the principal surface of the substrate; and
a lead line running through the sealing portion to connect the wiring line with an external circuit;
wherein the wiring line is formed to have so low resistance that voltage drop caused therein remain within a permissible extent, and
the lead line is formed as thin in the thickness at the sealing portion as the inside of the principal surface of the substrate is sealed.

17. A display device, according to claim 16, wherein the permissible extent is less than 0.5 V in the voltage drop.

18. A display device, according to claim 16, wherein the thickness of the lead line at the sealing portion is in a range of 20 100-500 nm.

19. A display device, comprising:
a substrate having a principal surface in an inside of which a plurality of electron emitter elements are arranged;
a sealing portion sealing the inside of the principal surface of the substrate; and
a wiring line formed in the inside of the principal surface of the substrate and a lead line connecting the wiring line with an external circuit,
wherein at least a part of the wiring line is formed of a material having low resistivity than that of the lead line at the sealing portion.

20. A display device, comprising:
a substrate having a principal surface in an inside of which a plurality of electron emitter elements are arranged;
a sealing portion sealing the inside of the principal surface of the substrate; and
a wiring line formed in the inside of the principal surface of the substrate and a lead line connecting the wiring line with an external circuit,
wherein at least a part of the wiring line is formed thicker in the thickness than that of the lead line at the sealing portion.

21. A display device, comprising:
a substrate having a principal surface in an inside of which a plurality of electron emitter elements are arranged;
a sealing portion sealing the inside of the principal surface of the substrate; and
a first wiring layer composes a scanning line in the inside of the principal surface of the substrate and passes through the sealing portion to be connected with an external circuit; and
a second wiring layer overlaps with at least a part of a portion of the first wiring layer composing the scanning line.

22. A display device, according to claim 21, wherein the second wiring layer is formed of a material having a low resistivity than that of the first wiring layer.

23. A display device, comprising:
a substrate having a principal surface in an inside of which a plurality of electron emitter elements are arranged;
a sealing portion sealing the inside of the principal surface of the-substrate; and
a first wiring layer composes a scanning line in the inside of the principal surface of the substrate; and
a second wiring layer overlaps with at least a part of the first wiring layer to compose a part of the scanning line and passes through the sealing portion to be connected with an external circuit.

24. A display device, according to claim 23, wherein the second wiring layer is formed of a material having a low resistivity than that of the first wiring layer.

25. A display device, according to claim 23, wherein the second wiring layer is formed to cover the first wiring layer thereby.

26. A display device, comprising:
a cathode substrate and an anode substrate both having principal surfaces opposite to each other;
a sealing portion sealing a space between the cathode substrate and the anode substrate;
a plurality of electron emitter elements and a wiring line connected to the plurality of electron emitter elements arranged on the principal surface of the cathode substrate in the space;
a lead line formed on the principal surface of the cathode substrate and connecting the wiring line with an external circuit,
wherein at least a part of the wiring line is lower in resistance than the lead line at the sealing portion,
the lead line is formed by sputtering, and
the wiring line is formed by screen printing.

27. A display device, according to claim 26, wherein the lead line is formed of a material selected from a first group consisting of Al, Cu, and Cr, or an alloy containing at least one selected from the first group, and
the wiring line is formed of a material selected from a second group consisting of Ag, Au, Cu, and Pd, or an alloy containing at least one selected from the second group.

28. A display device according to claim 26, wherein the wiring line has a first layer formed of a metal paste including frit on its base and a second layer formed of another metal paste not including frit on the first layer.

29. A display device according to claim 26, wherein the wiring line has a first layer formed of a first metal paste including frit on its base and a second layer formed of a second metal paste including a higher concentration of metals than that of the first metal paste on the first layer.

30. A circuit board, comprising:
an internal circuit formed on a principal surface of the circuit board; a sealing member sealing the internal circuit so as to keep a vacuum in an atmosphere of the internal circuit;
a lead line passing through the sealing portion and connecting the internal circuit with an external circuit,
wherein at least a part of the internal circuit is formed of a material having smaller resistivity than that of the lead line.
